(19) United States
(12) Patent Application Publication
(10) Pub. No.: US 2026/0347682 A1
(43) Pub. Date: Nov. 5, 2026

(54) CEMENT SLURRIES WITH SALT-TOLERANT FLUID LOSS ADDITIVES AND METHODS RELATING THERETO

(71) Applicant: Halliburton Energy Services, Inc., Houston, TX (US)

(72) Inventors: Sourav Ghosh, Pune (IN); Sandip Prabhakar Patil, Pune (IN); Manali Deepak Chimote, Pune (IN)

(73) Assignee: Halliburton Energy Services, Inc., Houston, TX (US)

(21) Appl. No.: 19/197,549

(22) Filed: May 2, 2025

(51) Int. Cl. C09K 8/487; C04B 7/02; C04B 22/00; C04B 22/12; C04B 24/12; C04B 24/16; C04B 28/04; C04B 103/00; C04B 103/40; C04B 103/46; C04B 111/00; C04B 111/40

(52) U.S. Cl. CPC C09K 8/487; C04B 7/02; C04B 22/0026; C04B 22/124; C04B 24/124; C04B 24/16; C04B 28/04; C04B 2103/0062; C04B 2103/40; C04B 2103/46; C04B 2111/00663; C04B 2111/40

(57) ABSTRACT

A method may include: introducing a cement slurry comprising a partially crosslinked non-grafted amphoteric liquid polymer fluid loss additive, cement, and water into a subterranean formation, wherein the partially crosslinked non-grafted amphoteric liquid polymer fluid loss additive comprises a polymerized product of 2-acrylamido-2-methylpropanesulfonic acid, N, N-dimethylacrylamide, methacrylatoethyl trimethyl ammoniumchloride, and acrylic acid (AA); and setting the cement slurry in the subterranean formation.

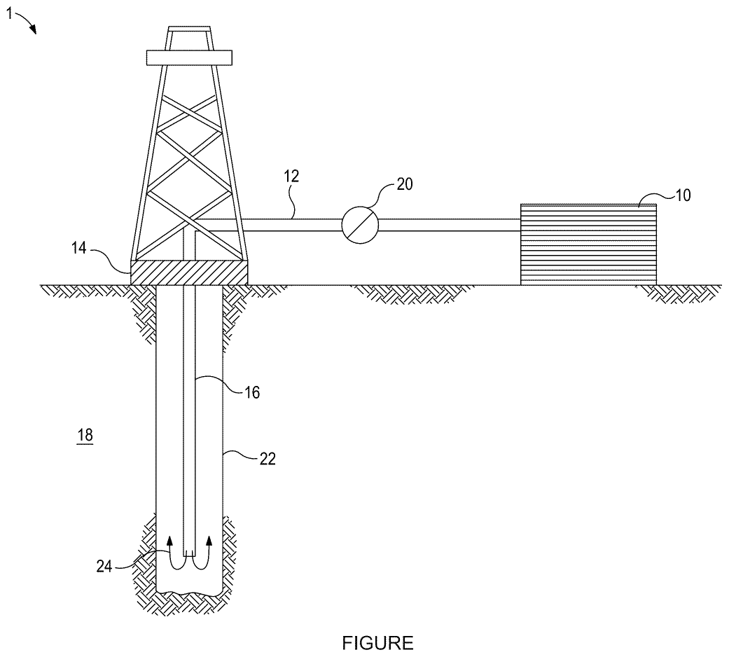

### BACKGROUND

Hydraulic cement compositions are commonly utilized in subterranean operations, particularly completion and remedial operations. For example, hydraulic cement compositions are used in primary cementing operations whereby pipe strings such as casings and liners are cemented in wellbores. For example, in performing primary cementing, cement slurries that include hydraulic cement may pumped into the annular space between the walls of a wellbore and the exterior surface of the pipe string disposed therein. The cement slurry is then permitted to set in the annular space, thereby forming a cement sheath that aids in supporting and positioning the pipe string in the wellbore and bonds the exterior surfaces of the pipe string to the walls of the wellbore. In another example, cement slurries that include hydraulic cement may also be used in remedial cementing operations such as plugging highly permeable zones or fractures in wellbores, plugging cracks and holes in pipe strings, and the like.

In many instances, a cement slurry may include a fluid loss control additive. As used herein, the term “fluid loss” refers to the undesirable migration or loss of fluids from the wellbore into a subterranean formation. Relative to a cement slurry, excessive fluid loss may, inter alia, causes the cement slurry to prematurely dehydrate, which may limit the amount of cement composition that can be pumped, decrease the compressive strength of the cement composition, and negatively impact bond strength between the set cement composition and a subterranean formation, the walls of pipe, and/or the walls of the wellbore.

However, the efficacy of traditional fluid loss additives, like copolymers of acrylamide and 2-acrylamido, 2-methyl propane sulfonic acid, can be greatly reduced with increasing salt concentration, especially magnesium salts. Salt is encountered in many oil-producing regions as, for example, salt domes in the formation and salt water in the formation. To counteract the efficacy reduction of a traditional fluid loss additive, the concentration of the fluid loss additive is usually increased. However, such increased amounts of the fluid loss additive may adversely affect cement slurry properties since these additives can also act as retarders and viscosifiers.

### BRIEF DESCRIPTION OF THE DRAWINGS

The following FIGURES are included to illustrate certain aspects of the embodiments described herein, and should not be viewed as exclusive embodiments. The subject matter disclosed is capable of considerable modifications, alterations, combinations, and equivalents in form and function, as will occur to those skilled in the art and having the benefit of this disclosure.

FIGURE depicts an embodiment of a system configured for delivering salt-tolerant cement slurries to a downhole location according to at least some embodiments described herein.

### DETAILED DESCRIPTION

Disclosed herein are salt-tolerant fluid loss additives, and more particularly, disclosed are methods and compositions including a salt-tolerant partially crosslinked non-grafted amphoteric liquid polymer fluid loss additive in cement slurries for use in subterranean cementing.

The salt-tolerant fluid loss additives disclosed herein include amphoteric polymers that provide fluid loss for cement slurries at moderate concentrations while in the presence of high salt concentrations. Additionally, salt-tolerant fluid loss additives described herein may be effective in the presence of magnesium salts. The ability to use moderate concentrations of the salt-tolerant fluid loss additives described herein may, in turn, minimally affect the properties of the cement slurry and resultant set cement.

Cement slurries described herein may include a base fluid, a salt-tolerant fluid loss additive, and a cementitious material. In embodiments, the salt-tolerant fluid loss additive comprises a partially crosslinked non-grafted amphoteric liquid polymer fluid loss additive.

### Polymer Fluid Loss Additive

The partially crosslinked non-grafted amphoteric liquid polymer fluid loss additive disclosed herein is a copolymer synthesized from monomers comprising 2-acrylamido-2-methylpropanesulfonic acid, N, N-dimethylacrylamide (NNDMA), methacrylatoethyl trimethyl ammoniumchloride (DMC), and acrylic acid (AA). In embodiments, the partially crosslinked non-grafted amphoteric liquid polymer fluid loss additive further comprises at least one monomer selected from sodium 2-acrylamido-2-methylpropanesulfonate, 4-vinylbenzenesulfonic acid, sodium 4-vinylbenzenesulfonate, vinylsulfonic acid, sodium vinylsulfonate, allylsulfonic acid, sodium allylsulfonate, 3-sulfopropyl acrylate potassium salt, 3-sulfopropyl methacrylate potassium salt, N-sulfomethylacrylamide sodium salt, sodium 1-allyloxy-2-hydroxypropanesulphonate, [2-(methacryloyloxy)ethyl]trimethylammonium chloride, [3-(methacryloylamino)propyl]trimethylammonium chloride, [2-(acryloyloxy)ethyl]trimethylammonium chloride, [3-(acryloylamino)propyl]trimethylammonium chloride, [2-(methacryloyloxy)ethyl]dimethylamine hydrochloride, [3-(methacryloylamino)propyl]dimethylamine hydrochloride, [2-(acryloyloxy)ethyl]dimethylamine hydrochloride, [3-(acryloylamino)propyl]dimethylamine hydrochloride, [3-(methacryloylamino)propyl]dimethyl(3-sulfopropyl)ammonium hydroxide inner salt, [2-(methacryloyloxy)ethyl]dimethyl(3-sulfopropyl)ammonium hydroxide inner salt, 2-(methacryloyloxy)ethyl 2-(trimethylammonio)ethyl phosphate, and combinations thereof. The foregoing sodium salts may include alternate counterions of potassium, magnesium, calcium, and/or ammonium, and the foregoing chloride salts may include alternate counterions of bromide, sulfate, and/or nitrate.

The partially crosslinked non-grafted amphoteric liquid polymer includes polymerized products comprising monomers disclosed above where the polymerized product is non-grafted, that is, a polymer without any side chains chemically attached to a backbone. The polymerized product consists of linear or branched chains where all segments are part of the same polymer type, without the addition of distinct side chains from another polymer.

In embodiments, the partially crosslinked non-grafted amphoteric liquid polymer fluid loss additive includes 2-acrylamido-2-methylpropanesulfonic acid in an amount at a point in a range of 20 mol. % to 40 mol. %. Alternatively, in an amount at a point in a range of 20 mol. % to 25 mol. %, 25 mol. % to 30 mol. %, 30 mol. % to 35 mol. %, 35 mol. % to 40 mol. %, or any ranges therebetween. In embodiments, the partially crosslinked non-grafted amphoteric liquid polymer fluid loss additive includes N, N-dimethylacrylamide in an amount at a point in a range of 20 mol. % to 40 mol. %. Alternatively, in an amount at a point in a range of 20 mol. % to 25 mol. %, 25 mol. % to 30 mol. %, 30 mol. % to 35 mol. %, 35 mol. % to 40 mol. %, or any ranges therebetween. In embodiments, the partially crosslinked non-grafted amphoteric liquid polymer fluid loss additive includes methacrylatoethyl trimethyl ammoniumchloride in an amount at a point in a range of 5 mol. % to 20 mol. %. Alternatively, in an amount at a point in a range of 5 mol. % to 10 mol. %, 10 mol. % to 15 mol. %, 15 mol. % to 20 mol. %, or any ranges therebetween. In embodiments, the partially crosslinked non-grafted amphoteric liquid polymer fluid loss additive includes acrylic acid in an amount at a point in a range of 5 mol. % to 20 mol. %. Alternatively, in an amount at a point in a range of 5 mol. % to 10 mol. %, 10 mol. % to 15 mol. %, 15 mol. % to 20 mol. %, or any ranges therebetween.

In embodiments, the partially crosslinked non-grafted amphoteric liquid polymer fluid loss additive disclosed herein is partially crosslinked using a crosslinker selected from N, N′-methylenebisacrylamide (MBA), N,N′-Diallyltartardiamide (DATD), Poly(ethylene glycol) Diacrylate (PEGDA), N,N′-Cystaminebisacrylamide (CBA), Tetraethylene Glycol Dimethacrylate (TEGDMA), Bis[2-(methacryloyloxy)ethyl] Phosphate (BMEP), N,N′-(1,2-Dihydroxyethylene)bisacrylamide (DHEBA), Glycerol Dimethacrylate (GDMA), N,N′-Ethylenebis(acrylamide) (EBA), 1,3-Propanediol Diacrylate (PDDA), Tris(2-hydroxyethyl) Isocyanurate Triacrylate (THEICTA), Bisacrylamide-Modified Polyethylene Glycol (Bis-PEG-Acrylamide), and combinations thereof. In embodiments, the crosslinker is present in the reaction mixture used to synthesize the partially crosslinked non-grafted amphoteric liquid polymer fluid loss additive at a point in a range of 50 parts per million (ppm) to 200 ppm. Alternatively, in an amount at a point in a range of 50 ppm to 100 ppm, 100 ppm to 150 ppm, 150 ppm to 200 ppm, or any ranges therebetween. In embodiments, the crosslinker is provided to at least partially crosslink components of the reaction mixture. As used herein partially crosslinked includes polymers with at least one crosslink per polymer molecule.

In embodiments, an initiator used to initiate the polymerization of the partially crosslinked non-grafted amphoteric liquid polymer fluid loss additive includes at least one initiator selected from sodium persulfate (Na₂S₂O₈), ammonium persulfate (APS, (NH₄)₂S₂O₈), tetramethylethylenediamine (TEMED), potassium persulfate (K₂S₂O₈), 2,2′-Azobis(2-methylpropionamidine) Dihydrochloride (AAPH), hydrogen peroxide (H₂O₂) with ferrous ion (Fe²⁺), 4,4′-Azobis(4-cyanovaleric Acid) (ACVA), and combinations thereof. In embodiments, the initiator is present in the reaction mixture used to synthesize the partially crosslinked non-grafted amphoteric liquid polymer fluid loss additive at a point in a range of 0.01 vol. % to 2 vol. %. Alternatively, the initiator is present at a point in a range of 0.01 vol. % to 0.1 vol. %, 0.1 vol. % to 1 vol. %, 1 vol. % to 2 vol. %, or any ranges therebetween.

In embodiments, the partially crosslinked non-grafted amphoteric liquid polymer fluid loss additive is synthesized in an aqueous solvent such as deionized water. In one procedure, the monomers of 2-acrylamido-2-methylpropane sulfonic acid, N, N-dimethylacrylamide, methacrylatoethyl trimethyl ammoniumchloride, and acrylic acid, along with any other monomers, including those listed above, are weighed and/or otherwise volumetrically metered into a reaction vessel which includes the aqueous solvent. The crosslinker N, N′-methylenebisacrylamide or other crosslinkers described as well as initiator sodium persulfate or other initiators described above are weighed and/or otherwise volumetrically metered into the reaction vessel. The reaction vessel may include stirrers or other equipment for agitating the reaction mixture during the reaction phase. In embodiments, the reaction mixture is kept at a pH of 7-9 using a basic solution such as NaOH or other Group I or Group II hydroxides. The reaction mixture may be heated during the reaction phase to a temperature of 40 °C to 90 °C.

The resultant polymerized product of partially crosslinked non-grafted amphoteric liquid polymer fluid loss additive may be removed from the reaction vessel and, in some embodiments, may be dissolved in additional aqueous solvent to a form a liquid additive comprising the partially crosslinked non-grafted amphoteric liquid polymer fluid loss additive. In embodiments, the partially crosslinked non-grafted amphoteric liquid polymer fluid loss additive may be present in a liquid additive at a point in a range of from 1 wt. % to 25 wt. % of the liquid additive. Alternatively, at a point in a range of from 1 wt. % to 5 wt. %, 5 wt. % to 10 wt. %, 10 wt. % to 15 wt. %, 15 wt. % to 20 wt. %, 20 wt. % to 25 wt. %, or any ranges therebetween.

The liquid additive comprising partially crosslinked non-grafted amphoteric liquid polymer fluid loss additive may have a viscosity as measured at 25 °C at a point in a range of 1000 cP (centipoise) to 1500 cP. Alternatively, a viscosity as measured at 25 °C at a point in a range of 1100 cP to 1200 cP, 1200 cP to 1300 cP, 1300 cP to 1400 cP, 1400 cP to 1500 cP, or any ranges therebetween.

### Cement Slurries

The cement slurries disclosed herein may include water, the partially crosslinked non-grafted amphoteric liquid polymer fluid loss additive, and a cementitious material. In some embodiments, the partially crosslinked non-grafted amphoteric liquid polymer fluid loss additive may be included in a cement slurry at a point in a range of from 0.01% weight of cement (BWOC) to 3% BWOC. Alternatively, in an amount at a point in a range of from 0.01% to 0.1% BWOC, 0.1% BWOC to 0.5% BWOC, 0.5% BWOC to 1% BWOC, 1% BWOC to 2% BWOC, 2% BWOC to 3% BWOC, or any ranges therebetween.

A variety of hydraulic cements may be utilized in accordance with the present disclosure, including, but not limited to, those comprising calcium, aluminum, silicon, oxygen, iron, and/or sulfur, which set and harden by reaction with water. Suitable hydraulic cements may include, but are not limited to, Portland cements, pozzolana cements, gypsum cements, alumina cements, silica cements, and any combination thereof. In certain examples, the hydraulic cement may include a Portland cement. In some examples, the Portland cements may include Portland cements that are classified as Classes A, C, H, and G cements according to API Specification 10A Twenty-Fifth Edition, March 2019 the entirety of which is incorporated by reference herein. In addition, hydraulic cements may include cements classified by American Society for Testing and Materials (ASTM) in C150-07 (Standard Specification for portland Cement) incorporated by reference herein, C595-08a (Standard Specification for Blended Hydraulic Cement) incorporated by reference herein or C1157-08a (Performance Specification for Hydraulic Cements) incorporated by reference herein such as those cements classified as ASTM Type I, II, III, IL, CL, or any other hydraulic cement suitable for a particular application. In embodiments the hydraulic cement includes Ordinary Portland Cement such as grade33, grade 43, and/or grade 53. The hydraulic cement may be included in the cement slurry in any amount suitable for a particular composition. Without limitation, the hydraulic cement may be included in the cement slurries in an amount in the range of from about 10% to about 80% by weight of dry blend in the cement slurry. For example, the hydraulic cement may be present in an amount ranging between any of and/or including any of about 10%, about 15%, about 20%, about 25%, about 30%, about 35%, about 40%, about 45%, about 50%, about 55%, about 60%, about 65%, about 70%, about 75%, or about 80% BWOB used to prepare a cement slurry.

The water utilized in the cement slurries may be from any source provided that it does not contain an excess of compounds that may undesirably affect other components in the cement slurries and/or acid solution. For example, a cement slurry may include fresh water and/or saltwater. Saltwater generally may include one or more dissolved salts therein and may be saturated or unsaturated as desired for a particular application. Seawater or brines may be suitable for use in some examples. Further, the water may be present in an amount sufficient to form a pumpable slurry. In certain examples, the water may be present in the cement slurry in an amount in the range of from about 33% to about 200% by weight of the cementitious materials. For example, the water in the cement may be present in an amount ranging between any of and/or including any of about 33%, about 50%, about 75%, about 100%, about 125%, about 150%, about 175%, or about 200% by weight of the cementitious materials. The cementitious materials referenced may include all components which contribute to the compressive strength of the cement slurry such as the hydraulic cement and supplementary cementitious materials, for example.

The cement slurry may include supplementary cementitious materials. The supplementary cementitious material may be any material that contributes to the desired properties of the cement slurry. Some supplementary cementitious materials may include, without limitation, fly ash, blast furnace slag, silica fume, pozzolans, kiln dust, and clays, for example.

The cement slurry may include kiln dust as a supplementary cementitious material. “Kiln dust,” as that term is used herein, refers to a solid material generated as a by-product of the heating of certain materials in kilns. The term “kiln dust” as used herein is intended to include kiln dust made as described herein and equivalent forms of kiln dust. Depending on its source, kiln dust may exhibit cementitious properties in that it can set and harden in the presence of water. Examples of suitable kiln dusts include cement kiln dust, lime kiln dust, and combinations thereof. Cement kiln dust may be generated as a by-product of cement production that is removed from the gas stream and collected, for example, in a dust collector. Usually, large quantities of cement kiln dust are collected in the production of cement that are commonly disposed of as waste. The chemical analysis of the cement kiln dust from various cement manufactures varies depending on a number of factors, including the particular kiln feed, the efficiencies of the cement production operation, and the associated dust collection systems. Cement kiln dust generally may include a variety of oxides, such as SiO₂, Al₂O₃, Fe₂O₃, CaO, MgO, SO₃, Na₂O, and K₂O. The chemical analysis of lime kiln dust from various lime manufacturers varies depending on several factors, including the particular limestone or dolomitic limestone feed, the type of kiln, the mode of operation of the kiln, the efficiencies of the lime production operation, and the associated dust collection systems. Lime kiln dust generally may include varying amounts of free lime and free magnesium, limestone, and/or dolomitic limestone and a variety of oxides, such as SiO₂, Al₂O₃, Fe₂O₃, CaO, MgO, SO₃, Na₂O, and K₂O, and other components, such as chlorides. Cement kiln dust (CKD) may include a partially calcined kiln feed which is removed from the gas stream and collected in a dust collector during the manufacture of cement. The chemical analysis of CKD from various cement manufactures varies depending on a number of factors, including the particular kiln feed, the efficiencies of the cement production operation, and the associated dust collection systems. CKD generally may comprise a variety of oxides, such as SiO₂, Al₂O₃, Fe₂O₃, CaO, MgO, SO₃, Na₂O, and K₂O. The CKD and/or lime kiln dust may be included in examples of the cement slurry in an amount suitable for a particular application.

In some examples, the cement slurry may further include one or more of slag, natural glass, shale, amorphous silica, or metakaolin as a supplementary cementitious material. Slag is generally a granulated, blast furnace by-product from the production of cast iron including the oxidized impurities found in iron ore. The cement may further include shale. A variety of shales may be suitable, including those including silicon, aluminum, calcium, and/or magnesium. Examples of suitable shales include vitrified shale and/or calcined shale. In some examples, the cement slurry may further include amorphous silica as a supplementary cementitious material. Amorphous silica is a powder that may be included in embodiments to increase cement compressive strength. Amorphous silica is generally a byproduct of a ferrosilicon production process, wherein the amorphous silica may be formed by oxidation and condensation of gaseous silicon suboxide, SiO, which is formed as an intermediate during the process

In some examples, the cement slurry may further include a variety of fly ashes as a supplementary cementitious material which may include fly ash classified as Class C, Class F, or Class N fly ash according to API Specification 10. In some examples, the cement slurry may further include zeolites as supplementary cementitious materials. Zeolites are generally porous alumino-silicate minerals that may be either natural or synthetic. Synthetic zeolites are based on the same type of structural cell as natural zeolites and may comprise aluminosilicate hydrates. As used herein, the term “zeolite” refers to all natural and synthetic forms of zeolite.

Where used, one or more of the aforementioned supplementary cementitious materials may be present in the cement slurry. For example, without limitation, one or more supplementary cementitious materials may be present in an amount of about 0.1% to about 80% by BWOB used to prepare a cement slurry. For example, the supplementary cementitious materials may be present in an amount ranging between any of and/or including any of about 0.1%, about 10%, about 20%, about 30%, about 40%, about 50%, about 60%, about 70%, or about 80% BWOB used to prepare a cement slurry.

In some examples, the cement slurry may further include hydrated lime. As used herein, the term “hydrated lime” will be understood to mean calcium hydroxide. In some embodiments, the hydrated lime may be provided as quicklime (calcium oxide) which hydrates when mixed with water to form the hydrated lime. The hydrated lime may be included in examples of the cement slurry, for example, to form a hydraulic composition with the supplementary cementitious components. For example, the hydrated lime may be included in a supplementary cementitious material-to-hydrated-lime weight ratio of about 10:1 to about 1:1 or 3:1 to about 5:1. Where present, the hydrated lime may be included in the set cement slurry in an amount in the range of from about 10% to about 100% by weight of the cement slurry, for example. In some examples, the hydrated lime may be present in an amount ranging between any of and/or including any of about 10%, about 20%, about 40%, about 60%, about 80%, or about 100% by weight of the cement slurry. In some examples, the cementitious components present in the cement slurry may consist essentially of one or more supplementary cementitious materials and the hydrated lime. For example, the cementitious components may primarily comprise the supplementary cementitious materials and the hydrated lime without any additional components (e.g., Portland cement, fly ash, slag cement) that hydraulically set in the presence of water.

Lime may be present in the cement slurry in several; forms, including as calcium oxide and or calcium hydroxide or as a reaction product such as when Portland cement reacts with water. Alternatively, lime may be included in the cement slurry by an amount of silica in the cement slurry. A cement slurry may be designed to have a target lime to silica weight ratio. The target lime to silica ratio may be a molar ratio, molal ratio, weight ratio, or any other equivalent way of expressing a relative amount of silica to lime. Any suitable target lime to silica weight ratio may be selected including from about 10/90 lime to silica (on a weight to weight basis) to about 40/60 lime to silica by weight. Alternatively, about 10/90 lime to silica by weight to about 20/80 lime to silica by weight, about 20/80 lime to silica by weight to about 30/70 lime to silica by weight, or about 30/70 lime to silica by weight to about 40/60 lime to silica by weight.

Other additives suitable for use in subterranean cementing operations also may be included in embodiments of the cement slurry. Examples of such additives include, but are not limited to: weighting agents, lightweight additives, gas-generating additives, mechanical-property-enhancing additives, lost-circulation materials, filtration-control additives, fluid-loss-control additives, defoaming agents, foaming agents, thixotropic additives, and combinations thereof. In embodiments, one or more of these additives may be added to the cement slurry after storing but prior to the placement of a cement slurry into a subterranean formation. In some examples, the cement slurry may further include a dispersant. Examples of suitable dispersants include, without limitation, sulfonated-formaldehyde-based dispersants (e.g., sulfonated acetone formaldehyde condensate) or polycarboxylated ether dispersants. In some examples, the dispersant may be included in the cement slurry in an amount in the range of from about 0.01% to about 5% by weight of the cementitious materials. In specific examples, the dispersant may be present in an amount ranging between any of and/or including any of about 0.01%, about 0.1%, about 0.5%, about 1%, about 2%, about 3%, about 4%, or about 5% BWOB used to prepare a cement slurry.

In some examples, the cement slurry may further include a set retarder. A broad variety of set retarders may be suitable for use in the cement slurries. For example, the set retarder may comprise phosphonic acids, such as ethylenediamine tetra(methylene phosphonic acid), diethylenetriamine penta(methylene phosphonic acid), etc.; lignosulfonates, such as sodium lignosulfonate, calcium lignosulfonate, etc.; salts such as stannous sulfate, lead acetate, monobasic calcium phosphate, organic acids, such as citric acid, tartaric acid, etc.; cellulose derivatives such as hydroxyl ethyl cellulose (HEC) and carboxymethyl hydroxyethyl cellulose (CMHEC); synthetic co- or ter-polymers comprising sulfonate and carboxylic acid groups such as sulfonate-functionalized acrylamide-acrylic acid co-polymers; borate compounds such as alkali borates, sodium metaborate, sodium tetraborate, potassium pentaborate; derivatives thereof, or mixtures thereof. Examples of suitable set retarders include, among others, phosphonic acid derivatives. Generally, the set retarder may be present in the cement slurry in an amount sufficient to delay the setting for a desired time. In some examples, the set retarder may be present in the cement slurry in an amount in the range of from about 0.01% to about 10% by weight of the cementitious materials. In specific examples, the set retarder may be present in an amount ranging between any of and/or including any of about 0.01%, about 0.1%, about 1%, about 2%, about 4%, about 6%, about 8%, or about 10% BWOB used to prepare a cement slurry.

In some examples, the cement slurry may further include an accelerator. A broad variety of accelerators may be suitable for use in the cement slurries. For example, the accelerator may include, but are not limited to, aluminum sulfate, alums, calcium chloride, calcium nitrate, calcium nitrite, calcium formate, calcium sulphoaluminate, calcium sulfate, gypsum-hemihydrate, sodium aluminate, sodium carbonate, sodium chloride, sodium silicate, sodium sulfate, ferric chloride, or a combination thereof. In some examples, the accelerators may be present in the cement slurry in an amount in the range of from about 0.01% to about 10% by weight of the cementitious materials. In specific examples, the accelerators may be present in an amount ranging between any of and/or including any of about 0.01%, about 0.1%, about 1%, about 2%, about 4%, about 6%, about 8%, or about 10% by BWOB used to prepare a cement slurry.

In some examples, the cement slurry may further include a fluid loss intensifier which may operate synergistically with the partially crosslinked non-grafted amphoteric liquid polymer fluid loss additive to facilitate fluid loss control. Examples of fluid loss intensifiers may include, but are not limited to, 2-acrylamido-2-methylpropane sulfonic acid, N,N dimethyl acrylamide, acrylamide terpolymer, copolymers thereof, any derivatives thereof, and any combination thereof. In some embodiments, a fluid loss intensifier may be included in a cement slurry in an amount ranging from a lower limit of about 0%, 0.001%, 0.01%, 0.05%, 0.1%, 0.2%, 0.3%, 0.4%, 0.5%, 0.6%, 0.7%, 0.8%, 0.9%, or 1% w/w of the complete dry components of the cement slurry to an upper limit of about 2%, 1.9%, 1.8%, 1.7%, 1.6%, 1.5%, 1.4%, 1.3%, 1.2% or 1% w/w of the complete dry components of the cement slurry, wherein the amount of the fluid loss intensifier may range from any lower limit to any upper limit and encompasses any subset therebetween.

In some examples, the cement slurry may further include an elastomer. The elastomers described herein may be used to impart elasticity to the set cement produced from the cement slurries described herein. In some embodiments, the elastomers may swell upon contact with water and/or oil (e.g., up to 500% of their original size). Such swelling may aid in maintaining zonal isolation in salt formations, for example, by swelling when contacted with water and/or oil to seal vulnerable spaces or cracks in set cement. In preferred embodiments, the elastomer swells upon contact with oil. The elastomers may additionally be weighted using a weighting agent. Weighting agents are typically materials that weigh more than water and may be used to increase the density of a cement slurry. Suitable weighting may include, but are not limited to, hematite, hausmannite, barite, sand, MnO₂, and any combination thereof. Examples of elastomers may include, but are not limited to, polypropylene, polyethylene, styrene divinyl benzene, polyisoprene, polybutadiene, polyisobutylene, polyurethane, a styrene-butadiene random copolymer, a styrene-butadiene block copolymer, acrylonitrile butadiene, acrylonitrile-styrene-butadiene, and any combinations thereof. In some embodiments, the elastomer material may be included in a cement slurry in an amount ranging from a lower limit of about 0%, 0.001%, 0.01%, 0.1%, 1%, 2%, 4%, 8%, or 10% w/w of the complete dry components of the cement slurry to an upper limit of about 20%, 18%, 16%, 14%, 12%, or 10% w/w of the complete dry components of the cement slurry, wherein the amount of the elastomer material may range from any lower limit to any upper limit and encompasses any subset therebetween.

Weight additives suitable may be used to increase the density of a cement slurry described herein. Increasing the density may allow for balancing the hydrostatic pressure exerted by the cement slurry and the formation pore pressure to stabilize the strength and permeability (e.g., salt contamination) of the cement. Weight additives are high-specific gravity solid particulates and may include, but are not limited to, hausmannite ore, barite, hermatite (Fe₂O₃), calcium carbonate, siderite (FeCO₃), ilmenite (FeO·TiO₂), and any combination thereof. Any weighting agent suitable for use with the elastomers described herein may additionally be used as a weight additive alone. Typically, the density of the weight additives of the of the embodiments disclosed herein range from about 1.05 g/cm³ to about 5.5 g/cm³. For example, calcium carbonate has a minimum specific gravity of about 2.7 g/cm³ and hematite has a minimum specific gravity of about 5.1 g/cm³. In some embodiments, the weighting agent may be included in a cement slurry in an amount ranging from a lower limit of about 0%, 0.001%, 0.01%, 0.1%, 1%, 2%, 4%, 6%, 8%, 10%, 12%, 14%, 18%, or 20% w/w of the complete dry components of the cement slurry to an upper limit of about 30%, 28%, 26%, 24%, 22%, or 20% w/w of the complete dry components of the cement slurry, wherein the amount of the weighting agent may range from any lower limit to any upper limit and encompasses any subset therebetween.

In some examples, the cement slurry may further include a dispersant. Dispersants suitable for use in a cement slurry described herein may affect the cement's rheological properties and reduce its apparent viscosity. The dispersant may thus allow turbulent flow to be achieved at lower pumping rates, resulting in reduced friction pressure during pumping. Additionally, adequately dispersed cement slurries exhibit improved fluid-loss control. Examples of dispersants may include, but are not limited to, sulfonated styrene maleic anhydride copolymer, sulfonated vinyltoluene maleic anhydride copolymer, sodium naphthalene sulfonate condensed with formaldehyde, sulfonated acetone condensed with formaldehyde, lignosulfonates and interpolymers of acrylic acid, allyloxybenzene sulfonate, allyl sulfonate and non-ionic monomers, and any combination thereof. In some embodiments, a dispersant may be included in a cement slurry in an amount ranging from a lower limit of about 0%, 0.001%, 0.01%, 0.1%, 0.5%, 1%, 1.5%, or 2% w/w of the complete dry components of the cement slurry to an upper limit of about 4%, 3.5%, 3%, 2.5%, or 2% w/w of the complete dry components of the cement slurry, wherein the amount of the dispersant may range from any lower limit to any upper limit and encompasses any subset therebetween.

In some examples, the cement slurry may further include a salt additive. A salt additive described herein may serve a dual purpose. First, the salt additive may prevent the cement slurry from reacting with formation chemistries to form particularly damaging salt products (e.g., MgCl). Second, the presence of the salt additive may prevent further dissolution of formation salts due to the cement slurry having spent its reactive chemistries on the salt present. The salt additive may be any simple salt compatible with use in a subterranean formation. In preferred embodiments, a salt additive may include, but is not limited to, sodium chloride, potassium chloride, calcium chloride or a combination thereof. In some embodiments, a salt additive may be included in a cement slurry at a point in a range of from 1% BWOC to 10% BWOC. Alternatively, at a point in a range of from 1% BWOC to 3% BWOC, 3% BWOC to 7% BWOC, 7% to 10% BWOC, or any ranges therebetween.

In embodiments, the cement slurries of the present disclosure may be foamed with a gas, for example, to provide a cement composition with a reduced density. Accordingly, in some embodiments, the cement slurries may be foamed and comprise cement, the partially crosslinked non-grafted amphoteric liquid polymer fluid loss additive, a surfactant, water, and a gas. Embodiments of the cement slurries further may comprise iron chloride and/or an alkali or alkaline-earth metal halide. Other suitable additives, such as those discussed previously, also may be included in embodiments of the foamed cement slurries. The gas used in embodiments of the foamed cement compositions of the present invention may be any gas suitable for foaming a cement composition, including, but not limited to, air, nitrogen, and combinations thereof. Generally, the gas should be present in the foamed cement slurries of in an amount sufficient to form the desired foam. In certain embodiments, the gas may be present in the foamed cement slurries in the range of about 5% to about 80% by volume of the foamed cement composition at atmospheric pressure, alternatively, in an amount of about 5% to about 55% by volume, and, alternatively, in an amount of about 15% to about 30% by volume.

Where foamed, embodiments of the settable compositions of the present invention comprise a surfactant for providing a suitable foam. In some embodiments, the surfactant comprises a foaming and stabilizing surfactant composition. As used herein, a “foaming and stabilizing surfactant composition” refers to a composition that comprises one or more surfactants and, among other things, facilitates the foaming of a cement slurries and also stabilizes the resultant foamed settable composition formed therewith. Any suitable foaming and stabilizing surfactant composition may be used in the cement slurries. Suitable foaming and stabilizing surfactant compositions may include, but are not limited to: mixtures of an ammonium salt of an alkyl ether sulfate, a cocoamidopropyl betaine surfactant, a cocoamidopropyl dimethylamine oxide surfactant, sodium chloride, and water; mixtures of an ammonium salt of an alkyl ether sulfate surfactant, a cocoamidopropyl hydroxysultaine surfactant, a cocoamidopropyl dimethylamine oxide surfactant, sodium chloride, and water; hydrolyzed keratin; mixtures of an ethoxylated alcohol ether sulfate surfactant, an alkyl or alkene amidopropyl betaine surfactant, and an alkyl or alkene dimethylamine oxide surfactant; aqueous solutions of an alpha-olefinic sulfonate surfactant and a betaine surfactant; and combinations thereof. In one certain embodiment, the foaming and stabilizing surfactant composition comprises a mixture of an ammonium salt of an alkyl ether sulfate, a cocoamidopropyl betaine surfactant, a cocoamidopropyl dimethylamine oxide surfactant, sodium chloride, and water.

Cement slurries generally should have a density suitable for a particular application. By way of example, the cement slurry may have a density in the range of from about 8 pounds per gallon (“ppg”) (959 kg/m³) to about 20 ppg (2397 kg/m³), or about 8 ppg to about 12 ppg (1437. kg/m³), or about 12 ppg to about 16 ppg (1917.22 kg/m³), or about 16 ppg to about 20 ppg, or any ranges therebetween. Examples of the cement slurry may be foamed or unfoamed or may comprise other means to reduce their densities, such as hollow microspheres, low-density elastic beads, or other density-reducing additives known in the art.

The rheological properties of a cement slurry may affect the slurry's gellation, flowability, and stability and, ultimately, its end-use performance. A cement slurry is generally considered adequate for use in subterranean operations and sufficiently pumpable when it exhibits a plastic viscosity (“PV”) of less than about 500 cP and a yield point (“YP”) of less than about 200 lb/100 ft², as defined by the conventional Bingham Plastic viscosity model. In some embodiments, a cement slurry described herein has a PV of less than about 500 cP and a YP of less than about 30 lb/100 ft². In other embodiments, a cement slurry described herein may have a PV in the range of a lower limit of about 120 cP, 140 cP, 160 cP, 180 cP, 200 cP, 220 cP, 240 cP, 260 cP, 280 cP, and 300 cP to an upper limit of about 500 cP, 480 cP, 460 cP, 440 cP, 420 cP, 400 cP, 380 cP, 360 cP, 340 cP, 320 cP, and 300 cP and a YP in the range of a lower limit of about 5 lb/100 ft², 25 lb/100 ft², 50 lb/100 ft², 75 lb/100 ft², and 100 lb/100 ft² to an upper limit of about 200 lb/100 ft², 175 lb/100 ft², 150 lb/100 ft², 125 lb/100 ft², and 100 lb/100 ft².

The cement slurries described herein that include salt-tolerant fluid loss additives may be useful in cementing operations in subterranean formation that include sodium salts, potassium salts, magnesium salts, calcium salts, or any combination thereof.

Some embodiments may involve introducing a cement slurry described herein that includes the partially crosslinked non-grafted amphoteric liquid polymer fluid loss additive into a wellbore penetrating a subterranean formation and setting the cement slurry therein to form a set cement. In some instances, the set cement may be a cement sheath disposed in an annular space between a casing and a wellbore wall. In some instances, the set cement may be a cement plug in the wellbore. In some instances, the cement slurry may be used to plug cracks or holes in an existing downhole set cement or pipe string.

In various embodiments, systems configured for preparing, transporting, and delivering the salt-tolerant cement slurries described herein to a downhole location are described. In various embodiments, the systems can comprise a pump fluidly coupled to a tubular (e.g., a casing, drill pipe, production tubing, coiled tubing, etc.) extending into a wellbore penetrating a subterranean formation, the tubular may be configured to circulate or otherwise convey a cement slurry described herein that includes salt-tolerant fluid loss additives. The pump may be, for example, a high pressure pump or a low pressure pump, which may depend on, inter alia, the viscosity and density of the cement slurry, the type of the cementing operation, and the like.

In some embodiments, the systems described herein may further comprise a mixing tank arranged upstream of the pump and in which the cement slurry is formulated. In various embodiments, the pump (e.g., a low pressure pump, a high pressure pump, or a combination thereof) may convey the cement slurry from the mixing tank or other source of the cement slurry to the tubular. In other embodiments, however, the cement slurry can be formulated offsite and transported to a worksite, in which case the cement slurry may be introduced to the tubular via the pump directly from a transport vehicle or a shipping container (e.g., a truck, a railcar, a barge, or the like) or from a transport pipeline. In yet other embodiments, the cementing fluid may be formulated on the fly at the well site where components of the cementing fluid are pumped from a transport (e.g., a vehicle or pipeline) and mixed during introduction into the tubular. In any case, the cement slurry may be drawn into the pump, elevated to an appropriate pressure, and then introduced into the tubular for delivery downhole. In embodiments, the partially crosslinked non-grafted amphoteric liquid polymer fluid loss additive is added to the cement slurry via a liquid additive pump and/or the partially crosslinked non-grafted amphoteric liquid polymer fluid loss additive can be added to the water utilized to prepare the cement slurry.

FIGURE shows an illustrative schematic of a system that can deliver a cement slurry described herein that includes the partially crosslinked non-grafted amphoteric liquid polymer fluid loss additive to a downhole location, according to one or more embodiments. It should be noted that while FIGURE generally depicts a land-based system, it is to be recognized that like systems may be operated in subsea locations as well. As depicted in FIGURE, system 1 may include mixing tank 10, in which cement slurry described herein may be formulated. Again, in some embodiments, the mixing tank 10 may represent or otherwise be replaced with a transport vehicle or shipping container configured to deliver or otherwise convey the cementing fluid to the well site. The cement slurry may be conveyed via line 12 to wellhead 14, where the cement slurry enters tubular 16 (e.g., a casing, drill pipe, production tubing, coiled tubing, etc.), tubular 16 extending from wellhead 14 into wellbore 22 penetrating subterranean formation 18. Upon being ejected from tubular 16, the cement slurry may subsequently return up the wellbore in the annulus between the tubular 16 and the wellbore 22 as indicated by flow lines 24. In other embodiments, the cement slurry may be reverse pumped down through the annulus and up tubular 16 back to the surface, without departing from the scope of the disclosure. Pump 20 may be configured to raise the pressure of the cement slurry to a desired degree before its introduction into tubular 16 (or annulus). It is to be recognized that system 1 is merely exemplary in nature and various additional components may be present that have not necessarily been depicted in FIGURE in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

It is also to be recognized that the cement slurries may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), wellbore projectiles (e.g., wipers, plugs, darts, balls, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIGURE.

Accordingly, the present disclosure may provide partially crosslinked non-grafted amphoteric liquid polymer fluid loss additive for use in cement slurries for use in subterranean cementing. The methods and compositions may include any of the various features disclosed herein, including one or more of the following statements.

Statement 1. A method comprising: introducing a cement slurry comprising a partially crosslinked non-grafted amphoteric liquid polymer fluid loss additive, cement, and water into a subterranean formation, wherein the partially crosslinked non-grafted amphoteric liquid polymer fluid loss additive comprises a polymerized product of 2-acrylamido-2-methylpropanesulfonic acid, N, N-dimethylacrylamide, methacrylatoethyl trimethyl ammoniumchloride, and acrylic acid (AA); and setting the cement slurry in the subterranean formation.

Statement 2. The method of statement 1 wherein the partially crosslinked non-grafted amphoteric liquid polymer fluid loss additive is present in an amount of about 0.01% to about 3% by weight of cement.

Statement 3. The method of any of statements 1-2 wherein the cement slurry further comprises a salt additive selected from the group consisting of sodium chloride, potassium chloride, calcium chloride, and combinations thereof.

Statement 4. The method of any of statements 1-3 wherein the salt additive is present in an amount of about 1% to about 10% by weight of the cement.

Statement 5. The method of any of statements 1-4 wherein the cement slurry is foamed.

Statement 6. The method of any of statements 1-5 wherein the cement slurry further comprises a surfactant and a gas.

Statement 7. The method of any of statements 1-6 wherein the surfactant comprises at least one surfactant selected from the group consisting of mixtures of an ammonium salt of an alkyl ether sulfate, cocoamidopropyl betaine, cocoamidopropyl dimethylamine oxide, hydrolyzed keratin, alkene amidopropyl betaine, alkyl or alkene dimethylamine oxide, alpha-olefinic sulfonate, and combinations thereof.

Statement 8. The method of any of statements 1-7 wherein the water comprises sea water.

Statement 9. The method of any of statements 1-8 wherein the partially crosslinked non-grafted amphoteric liquid polymer fluid loss additive is dissolved in water and is a liquid additive.

Statement 10. A cement slurry comprising: water; a cement; and a partially crosslinked non-grafted amphoteric liquid polymer fluid loss additive, cement, and water into a subterranean formation, wherein the partially crosslinked non-grafted amphoteric liquid polymer fluid loss additive comprises a polymerized product of 2-acrylamido-2-methylpropanesulfonic acid, N, N-dimethylacrylamide, methacrylatoethyl trimethyl ammoniumchloride, and acrylic acid.

Statement 11. The cement slurry of statement 10 wherein the partially crosslinked non-grafted amphoteric liquid polymer fluid loss additive is present in an amount of about 0.01% to about 3% by weight of cement.

Statement 12. The cement slurry of any of statements 10-11 wherein the cement slurry further comprises a salt additive selected from the group consisting of sodium chloride, potassium chloride, calcium chloride, and combinations thereof.

Statement 13. The cement slurry of any of statements 10-12 wherein the salt additive is present in an amount of about 1% to about 10% by weight of the cement.

Statement 14. The cement slurry of any of statements 10-13 wherein the cement slurry is foamed.

Statement 15. The cement slurry of any of statements 10-14 wherein the cement slurry further comprises a surfactant and a gas.

Statement 16. The cement slurry of any of statements 10-15 wherein the surfactant comprises at least one surfactant selected from the group consisting of mixtures of an ammonium salt of an alkyl ether sulfate, cocoamidopropyl betaine, cocoamidopropyl dimethylamine oxide, hydrolyzed keratin, alkene amidopropyl betaine, alkyl or alkene dimethylamine oxide, alpha-olefinic sulfonate, and combinations thereof.

Statement 17. The cement slurry of any of statements 10-16 wherein the water comprises sea water.

Statement 18. A method of making a partially crosslinked non-grafted amphoteric liquid polymer fluid loss additive comprising: polymerizing monomers comprising 2-acrylamido-2-methylpropanesulfonic acid, N, N-dimethylacrylamide, methacrylatoethyl trimethyl ammoniumchloride, and acrylic acid to form a polymerized product; and partially crosslinking the polymerized product using a crosslinker to form the partially crosslinked non-grafted amphoteric liquid polymer fluid loss additive.

Statement 19. The method of statement 18 wherein the crosslinker comprises N, N′-methylenebisacrylamide.

Statement 20. The method of any of statements 18-19 wherein the partially crosslinked non-grafted amphoteric liquid polymer fluid loss additive has a viscosity measured at 25 °C of about 1000 cP to about 1500 cP.

To facilitate a better understanding of the present invention, the following example of certain aspects of some embodiments are given. In no way should the following example be read to limit, or define, the entire scope of the disclosure.

### Example

In this example, a partially crosslinked non-grafted amphoteric liquid polymer fluid loss additive was synthesized and tested. Additional test polymers were synthesized and comparatively tested against the partially crosslinked non-grafted amphoteric liquid polymer fluid loss additive.

Four test polymers (Pol-A, Pol-B, Pol-C, and Pol-D) and one partially crosslinked non-grafted amphoteric liquid polymer (Pol-E) were synthesized using the monomer ratios in Table 1.

The polymerization was conducted in deionized water. In a typical procedure, monomers of 2-acrylamido-2-methylpropane sulfonic acid, N, N-dimethylacrylamide (NNDMA), methacrylatoethyl trimethyl ammoniumchloride (DMC), acrylic acid (AA), were dissolved in distilled water in the ratios indicated in Table 1 in a three-neck flask at room temperature. The crosslinker, N, N′-methylenebisacrylamide (MBA), was added at a concentration of 100 ppm and dissolved along with the monomers. After adjusting the pH to 7-8 using an NaOH solution, the mixture was stirred under an inert nitrogen atmosphere for 30 minutes. The temperature was then increased to 50 °C, and the first portion of the sodium persulfate (Na₂S₂O₈) initiator (0.015 mol) was added. After 50 minutes of reaction time, the second portion of the initiator (0.015 mol) was added, and the temperature was increased to 60 °C. Polymerization continued for another 70 minutes, during which the pH was maintained at 7-8 by metering in NaOH solution. The temperature was then increased to 70 °C, and the mixture was allowed to react for an additional hour. Finally, the temperature was increased to 80 °C for another hour to complete the reaction. The liquid was then cooled to room temperature.

The viscosity of each synthesized polymer was measured at 25 °C, the result of each which is shown in Table 1. The synthesis of Pol-E resulted in a 14 wt. % aqueous polymer solution (Pol-E) with a viscosity of approximately 1300 cP at 25 °C. It was further observed that Pol-A was a viscous mass, Pol-B was a highly viscous mass, Pol-C had a viscosity of 500 cP, and Pol-D had a viscosity of 700 cP.

TABLE 1

| | Pol-A | Pol-B | Pol-C | Pol-D | Pol-E |
|---|---|---|---|---|---|
| 2-acrylamido-2- | 1 | 1 | 1 | 1 | 1 |
| methylpropane sulfonic | | | | | |
| acid, mol | | | | | |
| N-dimethylacrylamide, | 1 | 1 | 1 | 1 | 1 |
| mol | | | | | |
| methacrylatoethyl | 0.25 | | 0.25 | 0.25 | 0.25 |
| trimethyl | | | | | |
| ammoniumchloride, mol | | | | | |
| Acrylic acid, % | — | 0.25 | 0.25 | 0.125 | 0.25 |
| N,N′- | — | — | — | — | 100 |
| methylenebisacrylamide, | | | | | |
| ppm | | | | | |
| Viscosity of polymer, cP | Viscous | Highly | 500 | 700 | 1300 |
| (at 25 °C) | mass | viscous | | | |

The synthesized polymers were utilized in a cement slurry using the formulation of Table 2 indicated by weight of cement (BWOC). All the fluid loss additives used were liquid and taken based on the active solid content. The cement slurries were mixed according to the API procedure recommended practice 10B-2. Thereafter, the slurries were conditioned at 50 °F in an atmospheric consistometer. After conditioning, fluid loss control testing was conducted at 50 °F, adhering to the standard API procedure recommended practice 10B-2. The results of the fluid loss testing are shown in Table 3. The synthesized fluid loss polymers were also compared to a commercially available fluid loss polymer DeepFX-L available from Halliburton Energy Services, Inc. It was observed that the Pol-E had the least amount of fluid loss of the tested polymers.

TABLE 2

| MATERIALS | UoM | Quantity |
|---|---|---|
| Class H Cement | % BWOC | 100 |
| Sea Water | gps | 4.52 |
| Desegregating Agent | % BWOC | 0.07 |
| KCl (Potassium Chloride) Salt | lb/sk | 1.8 |
| Foaming Agent | gps | 0.12 |
| Fluid Loss Additive | % BWOC | 0.67 |
| CaCl₂ Liquid | gps | 0.13 |

TABLE 3

| Testing | DeepFX-L | Pol-A | Pol-B | Pol-C | Pol-D | Pol-E |
|---|---|---|---|---|---|---|
| API Fluid | 220 | 56 | 42 | 80 | 58 | 38 |
| Loss, | | | | | | |
| mL/30 min, | | | | | | |
| 50 °F | | | | | | |

The thickening time, zerogel time, transition time, compressive strength, and foam stability were tested for a cement slurry containing DeepFX-L and Pol-E. The results of the testing are shown in Table 4. It was observed that the slurry containing Pol-E had improvement in thickening time, zerogel time, transition time, and compressive strength compared to the commercially available fluid loss polymer.

TABLE 4

| Testing | DeepFX-L | Pol-E |
|---|---|---|
| Thickening time (70 Bc), min | 510 | 484 |
| Zerogel time & Transition time, | 80 & 58 | 131 & 37 |
| min | | |
| UCA, 24 Hrs Compressive | 900 | 1145 |
| Strength, psi | | |
| Foam stability (Top to Bottom | 0.3 | 0.5 |
| density variation, ppg) | | |

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

The invention claimed is:

1. A method comprising:
introducing a cement slurry comprising a partially crosslinked non-grafted amphoteric liquid polymer fluid loss additive, cement, and water into a subterranean formation, wherein the partially crosslinked non-grafted amphoteric liquid polymer fluid loss additive comprises a polymerized product of 2-acrylamido-2-methylpropanesulfonic acid, N, N-dimethylacrylamide, methacrylatoethyl trimethyl ammoniumchloride, and acrylic acid (AA); and
setting the cement slurry in the subterranean formation.

2. The method of claim 1 wherein the partially crosslinked non-grafted amphoteric liquid polymer fluid loss additive is present in an amount of about 0.01% to about 3% by weight of cement.

3. The method of claim 1 wherein the cement slurry further comprises a salt additive selected from the group consisting of sodium chloride, potassium chloride, calcium chloride, and combinations thereof.

4. The method of claim 3 wherein the salt additive is present in an amount of about 1% to about 10% by weight of the cement.

5. The method of claim 1 wherein the cement slurry is foamed.

6. The method of claim 4 wherein the cement slurry further comprises a surfactant and a gas.

7. The method of claim 6 wherein the surfactant comprises at least one surfactant selected from the group consisting of mixtures of an ammonium salt of an alkyl ether sulfate, cocoamidopropyl betaine, cocoamidopropyl dimethylamine oxide, hydrolyzed keratin, alkene amidopropyl betaine, alkyl or alkene dimethylamine oxide, alpha-olefinic sulfonate, and combinations thereof.

8. The method of claim 1 wherein the water comprises sea water.

9. The method of claim 1 wherein the partially crosslinked non-grafted amphoteric liquid polymer fluid loss additive is dissolved in water and is a liquid additive.

10. A cement slurry comprising:
water;
a cement; and
a partially crosslinked non-grafted amphoteric liquid polymer fluid loss additive, cement, and water into a subterranean formation, wherein the partially crosslinked non-grafted amphoteric liquid polymer fluid loss additive comprises a polymerized product of 2-acrylamido-2-methylpropanesulfonic acid, N, N-dimethylacrylamide, methacrylatoethyl trimethyl ammoniumchloride, and acrylic acid.

11. The cement slurry of claim 10 wherein the partially crosslinked non-grafted amphoteric liquid polymer fluid loss additive is present in an amount of about 0.01% to about 3% by weight of cement.

12. The cement slurry of claim 10 wherein the cement slurry further comprises a salt additive selected from the group consisting of sodium chloride, potassium chloride, calcium chloride, and combinations thereof.

13. The cement slurry of claim 12 wherein the salt additive is present in an amount of about 1% to about 10% by weight of the cement.

14. The cement slurry of claim 10 wherein the cement slurry is foamed.

15. The cement slurry of claim 14 wherein the cement slurry further comprises a surfactant and a gas.

16. The cement slurry of claim 15 wherein the surfactant comprises at least one surfactant selected from the group consisting of mixtures of an ammonium salt of an alkyl ether sulfate, cocoamidopropyl betaine, cocoamidopropyl dimethylamine oxide, hydrolyzed keratin, alkene amidopropyl betaine, alkyl or alkene dimethylamine oxide, alpha-olefinic sulfonate, and combinations thereof.

17. The cement slurry of claim 10 wherein the water comprises sea water.

18. A method of making a partially crosslinked non-grafted amphoteric liquid polymer fluid loss additive comprising:
polymerizing monomers comprising 2-acrylamido-2-methylpropanesulfonic acid, N, N-dimethylacrylamide, methacrylatoethyl trimethyl ammoniumchloride, and acrylic acid to form a polymerized product; and
partially crosslinking the polymerized product using a crosslinker to form the partially crosslinked non-grafted amphoteric liquid polymer fluid loss additive.

19. The method of claim 18 wherein the crosslinker comprises N, N′-methylenebisacrylamide.

20. The method of claim 18 wherein the partially crosslinked non-grafted amphoteric liquid polymer fluid loss additive has a viscosity measured at 25 °C of about 1000 cP to about 1500 cP.
